(19) United States
(12) Patent Application Publication
(10) Pub. No.: US 2011/0282316 A1
(43) Pub. Date: Nov. 17, 2011

(54) METHODS FOR BUFFERING MEDICAL SOLUTIONS

(75) Inventors: Matthew J. Stepovich, Santa Cruz, CA (US); Michael I. Falkel, Carmel Highlands, CA (US); Harry Nguyen, Westminster, CA (US)

(73) Assignee: Onpharma Inc., Los Gatos, CA (US)

(21) Appl. No.: 12/944,492

(22) Filed: Nov. 11, 2010

Related U.S. Application Data
(63) Continuation-in-part of application No. 12/766,259, filed on Apr. 23, 2010.
Application No. 12/766,259 is a continuation-in-part of application No. 12/406,670, filed on Mar. 18, 2009.
(60) Provisional application No. 61/094,669, filed on Sep. 5, 2008.
(60) Provisional application No. 61/054,930, filed on May 21, 2008.
(60) Provisional application No. 61/281,045, filed on Nov. 12, 2009.
(60) Provisional application No. 61/270,571, filed on Jul. 9, 2009.
(60) Provisional application No. 61/276,137, filed on Sep. 8, 2009.

(51) Int. Cl. A61J 1/20; A61J 1/14

(52) U.S. Cl. 604/414; 604/416

(57) ABSTRACT

A device for delivering buffer solution into a buffer cartridge comprises a needle assembly and a pusher. The septa of a buffer cartridge and an anesthetic cartridge are advanced onto a transfer needle, and the pusher advances a plunger into the buffer cartridge to deliver buffer through the transfer needle into the anesthetic cartridge. A separate exhaust needle allows excess anesthetic from the anesthetic cartridge to be exhausted. A compression member is usually provided to maintain a force against the plunger on the buffer cartridge to pressurize and stabilize the contents during sterilization and/or storage. By delivering a buffer with a precisely controlled pH, accurate buffering of the anesthetic can be achieved.

### CROSS-REFERENCES TO RELATED APPLICATIONS

This application is a continuation-in-part of application Ser. No. 12/406,670 (Attorney Docket No. 027239-000420US), filed on Mar. 18, 2009, which claims the benefit of prior provisional application 61/054,930 (Attorney Docket No. 027239-000400US), filed on May 21, 2008, and of provisional application 61/094,669 (Attorney Docket No. 027239-000410US), filed on Sep. 5, 2008, the full disclosures of which are incorporated herein by reference.

The present application is also a continuation-in-part of application Ser. No. 12/766,259 (Attorney Docket No. 027239-000600US), filed on Apr. 4, 2010, which claims the benefit of prior provisional application Nos. 61/270,571, filed on Jul. 9, 2009, and 61/276,137, filed on Sep. 8, 2009, the full disclosures of which are incorporated herein by reference.

The present application also claims the benefit of provisional application 61/281,045, filed Nov. 12, 2009, the full disclosure of which is incorporated herein by reference.

### BACKGROUND OF THE INVENTION

1. Field of the Invention

The present invention relates generally to methods and apparatus for buffering medical solutions. More particularly, the present invention relates to methods for combining sodium bicarbonate buffering solutions with anesthetics and other medical solutions stored in small cartridges.

Aqueous solutions containing bicarbonate ions are used in various medical applications such as antidotes, dialysates, artificial cerebrospinal fluid, intraocular irrigating solutions, cardiac perfusates, cardioplegic solutions, peritoneal irrigating solutions, and solutions for organ preservation, etc. Of particular interest to the present application bicarbonates solutions are used to buffer dental and other anesthetics to control pH. One of the most commonly used medical bicarbonate solutions consists of sodium bicarbonate (NaHCO₃) mixed with water (H₂O). In medical bicarbonate solutions, bicarbonate ions are in equilibrium as represented by the following expression:

2HCO₃⁻ [symbol] CO₂↑+CO₃²⁻+H₂O

If the reaction occurs in a closed system, equilibrium is reached with the amounts of reactants remaining constant. In open systems, however, the carbon dioxide gas escapes and the reaction proceeds from the left to the right with bicarbonate (2HCO₃) evolving into carbon dioxide gas (CO₂), carbonate (CO₃) and water (H₂O), progressively decreasing the concentration of bicarbonate ions and increasing the concentration of carbonate ions. Since carbonate ions are more alkaline than bicarbonate ions, the pH of the solution will progressively increase.

Clinical effectiveness of bicarbonate medical solutions often depends on maintenance of a particular pH range, generally from 7 to 9. For some applications, maintaining the pH in a more narrow range is beneficial. To stabilize pH and CO₂ content, sodium bicarbonate solutions are conventionally packed in gas tight containers that limit leakage of evolved carbon dioxide into the atmosphere. By limiting the loss of evolved CO₂, pH change may be reduced. As CO₂ leaves solution and enters the container's “headspace” (the gas-filled region above the solution) the partial pressure of the evolved CO₂ will increase and eventually establish equilibrium between CO₂ leaving solution and CO₂ returning to solution.

The gas tight container most commonly used to store medical bicarbonate solutions is a glass vial with a pierceable rubber cap referred to as a septum. Such vials allow the medical practitioner to pierce the septum with a hypodermic needle and withdraw or “draw up” a desired volume of bicarbonate solution into a syringe. To facilitate withdrawing the bicarbonate, the vials typically include a significant headspace that prevents a vacuum from forming when the practitioner attempts to draw up the fluid. Once the fluid is drawn up into a syringe, the syringe can be used to deliver the fluid into a catheter or a blood vessel. The partially filled syringe may be used to draw up a second solution, such as a local anesthetic, from another vial in order to mix the second solution with the sodium bicarbonate, where the syringe serves as a mixing and delivery vessel for the resulting pH buffered solution.

Of particular interest to the present application, bicarbonate solutions may be used to buffer acidic local anesthetic injections in order to enhance anesthetic effectiveness, speed the onset of analgesia, reduce injection pain, and limit tissue trauma. When using sodium bicarbonate for buffering local anesthetic or other parenteral solutions, a predetermined volume of sodium bicarbonate will be combined with a known volume of anesthetic or other parenteral solution in order to achieve a target buffered pH.

This approach will work so long as the pH of the buffer is precisely known. For example, when compounding 8.4% sodium bicarbonate buffer solution with commercially available cartridges of 2% lidocaine with epinephrine 1:100,000, the pH of the buffer solution will tend to drive the pH of the combination, almost exclusively of the pH of the commercially available anesthetic cartridges, such that a relatively small volume of buffer solution will have a disproportionately large impact on the pH of the combined solution. Thus, to achieve a parenteral or other medical solution with a precisely controlled target pH, it is important that the pH of the buffer solution be precisely known and accounted for in determining the volume of buffer to be combined.

Commercially produced sodium bicarbonate buffers do not provide buffer packages with precisely controlled pH. For example, commercially available buffering solutions list a very large pH range on their labels, with sodium bicarbonate solutions typically labeled from pH 7.0 to pH 8.5. An assay of a small sample of the commercially available sodium bicarbonate solutions performed by the inventors showed a pH range from 7.62 to 8.26. Presumably the actual range of the product available in the marketplace is even wider than the range found in this assay.

It must be appreciated, in this context, that regardless of the nominal pH, a medical buffer having an actual pH of 7.0 may perform significantly differently than a medical buffer having an actual pH of 8.5. This is true whether the medical buffer is designed to buffer the pH of the body's fluids, for instance in the treatment of acidosis, or the medical buffer is designed to buffer the pH of an anesthetic or other parenteral solution prior to its use. In the example where a practitioner uses sodium bicarbonate solution to buffer anesthetic to achieve physiologic pH, the ratio of buffer solution to anesthetic solution will be quite different when the pH of the bicarbonate solution is 7.0 compared to when the pH is 8.5. Thus, prior art methods of combining buffering solution with parenteral solutions which rely on adding the same ratio of buffering solution to the parenteral solution (regardless of the actual pH of the buffer) will not consistently arrive at the desired pH for the buffered parenteral.

While it would theoretically be possible to measure the pH of each and every sodium bicarbonate or other buffer solution prior to use in order to allow a precise computation of the pH and/or adjustment of the volume of buffer to be combined with the medical solution, performing such pH measurements is not practical and may not be safe, since the most commonly-used pH meters can impart toxics into the solution being tested.

For these reasons, it would be desirable to provide improved methods for combining buffer solutions with anesthetics and other medical solutions, particularly using buffer solutions held in conventional glass cartridges. It would be particularly beneficial if the methods allowed the use of buffer cartridges of a type commonly used when buffering anesthetics and other medical solutions. It would be still further desirable if the methods could provide a buffered anesthetic or other medical solution with a precise and repeatable pH without the need to measure, calculate, customize or take any other steps to specially adjust the pH of the buffer and/or medical solution prior to combining them. At least some of these objectives will be met by the inventions described hereinbelow.

2. Description of the Background Art

The benefits of injecting pH buffered anesthetics are discussed in Whitcomb, et al. (2010) Anesth. Prog. 57:59-66. Glass vials and cartridges for storing medical solutions are described in U.S. Pat. Nos. 1,757,809; 2,484,657; 4,259,956; 5,062,832; 5,137,528; 5,149,320; 5,226,901; 5,261,903; 5,330,426; and 6,022,337. Injection pens which employ drug cartridges are described in U.S. Pat. No. 5,984,906. A particular disposable drug cartridge that can find use in the present invention is described in U.S. Pat. No. 5,603,695. A device for delivering a buffering agent into an anesthetic cartridge using a transfer needle is described in U.S. Pat. No. 5,603,695. Devices for maintaining a dissolved gas in solution in a pouch are described in U.S. Pat. Nos. 5,690,215; 5,610,170; and 4,513,015, and U.S. Patent Publ. No. 2007/0265593. Other patents and applications of interest include U.S. Pat. Nos. 2,604,095; 3,993,791; 4,154,820; 4,630,727; 4,654,204; 4,756,838; 4,959,175; 5,296,242; 5,383,324; 5,603,695; 5,609,838; 5,779,357; and U.S. Patent Publ. Nos. 2004/0175437 and 2009/0221984. APP Pharmaceutical, LLC, Schaumburg, Ill. 60173 sells Sodium Bicarbonate 4.2% Neutralizing Additive Solution (2.5 mEq/ml), see Product Label April 2008.

### BRIEF SUMMARY OF THE INVENTION

The present invention provides a method for buffering anesthetics and other medical and parenteral solutions for use in medical procedures. As discussed above, it is often advantageous to precisely and repeatably control the pH of a medical solution before it is administered to a patient for a variety of reasons. In particular, the method of the present invention provides for buffering a known volume of a medical solution held in a container by combining the medical solution with a selected volume of a sodium bicarbonate buffer held in a container. By carefully controlling the pH of the sodium bicarbonate buffer, typically within ±0.2 pH unit, preferably within ±0.1 pH units, the actual pH of the resulting buffered solution can be maintained within ±0.2 pH units of the target pH value, preferably being within ±0.1 pH unit of the target pH value. In the exemplary embodiments, the medical solution comprises an anesthetic solution, such as lidocaine, articaine, or mepivicaine, bupivacaine, optionally combined with epinephrine, neo-cobefrin (or other vasoconstrictors) or hyaluronidase.

The methods of the present invention are conveniently carried out using “dosing pens” where a container of the anesthetic or other medical solution container and a separate container of the sodium bicarbonate buffer are placed together in the pen. The pen is then automatically actuated to transfer a preselected amount (volume) of the buffer into the medical solution container. Preferably, the same dosing pen can be used to deliver buffer to more than one anesthetic or other medical solution container. In specific examples, a first end of a transfer needle is penetrated through a septum in the buffer container and a second end of the transfer needle is penetrated through a septum in the medical solution container. The selected volume of buffer is then caused to flow through the transfer needle from the buffer container to the medical solution container. Usually, a separate exhaust needle is penetrated through the septum in the medical solution container to allow excess medical solution to bleed from the medical solution container as buffer enters the container. Conveniently, buffer may be caused to flow from the buffer container by advancing a plug in a wall or at the bottom of the buffer container to displace the selected volume and flow said volume to the medical solution container.

In specific examples, the medical solution may comprise lidocaine with epinephrine where pH of the sodium bicarbonate buffer should be 7.7±0.3, preferably 7.65±0.15, ideally 7.6±0.1, and is combined with the lidocaine with epinephrine at a concentration of 1.0 mL sodium bicarbonate per 10 mL ml lidocaine with epinephrine to achieve a buffered pH of 7.2±0.2. Similarly, when the medical solution comprises other local anesthetics, with or without epinephrine, other amounts of sodium bicarbonate may be added to the anesthetic solutions to achieve a buffered pH of 7.2±0.2.

### BRIEF DESCRIPTION OF THE DRAWINGS

FIG. 1 illustrates a medical solution container useful in the practice of the present invention.

FIG. 2 illustrates a plurality of the containers of FIG. 1 held in a carrier used for placing them within a chamber for treatment in accordance with the principles of the present invention.

FIG. 3 illustrates an exemplary treatment chamber in accordance with the principles of the present invention.

FIG. 4 illustrates a humidifying system useful with the treatment chamber of FIG. 3.

FIGS. 5A-5C illustrate placement of the container carriers into the treatment chamber through pneumostatic ports.

FIG. 6 is a schematic illustration of the pH adjustment protocols of the present invention.

FIG. 7 is a perspective view illustrating the buffer transfer device of the present invention and a conventional anesthetic cartridge.

FIG. 8 is an exploded view of the buffer transfer device illustrating the knob, housing, buffer cartridge, spring, and pusher components thereof.

FIG. 9 is a cross-sectional view of the buffer transfer device of FIGS. 7 and 8 shown prior to penetrating a transfer needle through a septum of the buffer cartridge where the spring remains under compression applying pressure to the buffer within the buffer cartridge.

FIG. 9A is a detailed view of a stop member taken along line 9A-9A of FIG. 9.

FIG. 10 is a cross-sectional view of the buffer transfer device similar to FIG. 9, except that the transfer needle has been penetrated through the septum of the buffer cartridge and the release of pressure has allowed the spring to advance a plunger of the buffer cartridge to expel a small volume of the buffer and prime the transfer needle.

FIG. 11 is an enlarged, detailed cross-sectional view of the knob and needle components of the buffer transfer device of the present invention.

FIG. 11A is a further enlarged, detailed cross-sectional view illustrating the septum on the buffer cartridge.

FIG. 12 is a cross-sectional view of a buffer transfer device similar to that shown in FIGS. 3 and 4 except that an anesthetic cartridge has been inserted into a receptacle formed in the knob to cause the transfer needle and an exhaust needle to penetrate a septum of the anesthetic cartridge.

FIG. 13 is a cross-sectional view similar to those of FIGS. 9, 10, and 12, except that the pusher has been advanced through a first length of travel in order to deliver a first volume of buffer from the buffer cartridge into the attached anesthetic cartridge.

FIGS. 14A-14D are schematic illustrations of stop members on the housing which limit and control travel of the pusher to allow first and second sequential volume deliveries from the buffer transfer device.

### DETAILED DESCRIPTION OF THE INVENTION

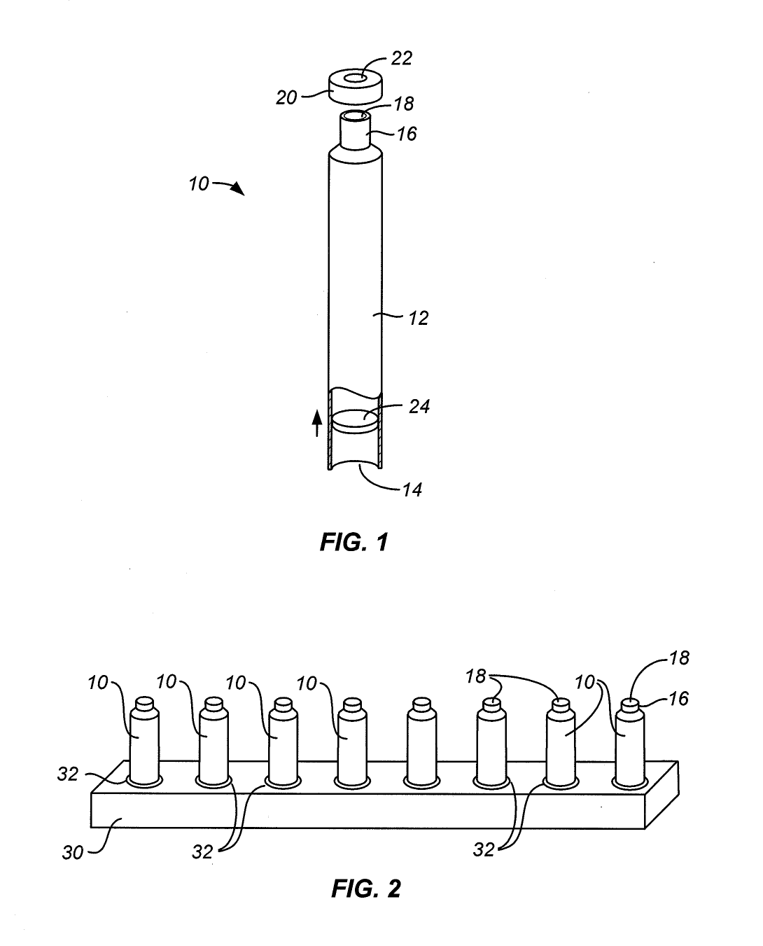

A buffer container 10 containing a sodium bicarbonate buffer with a precisely controlled pH useful in the methods of the present invention is illustrated in FIG. 1. The buffer container 10 comprises a cartridge 12 including a glass cylindrical body having an open bottom 14. A reduced diameter neck 16 is at the top with an opening 18 which can be covered and sealed with a cap 20 with a needle-penetrable septum 22. The bottom of the cartridge 12 is defined by a movable plunger 24 which can be pushed in an upward direction (indicated by the arrow) to apply pressure on the aqueous buffer held within the cartridge 12 between the plunger and the opening 18 in neck 16. The construction of buffer container 10 as just described is conventional within the art.

The pH of the sodium bicarbonate buffer in a plurality of the cartridges 10 can be precisely and repeatably adjusted to a target value as follows. Buffer containers 10 may be held in a carrier 30 which includes a plurality of receptacles 32, each of which receives an individual container 10 and holds that container in an upright orientation with the opening 18 in the neck 16 being upwardly exposed. The carriers may have a variety of configurations, but will usually be elongate structures which allow for convenient insertion and removal of the trays through pneumostatic ports in the equilibration chamber, as described in more detail below. For example, the carriers 30 may comprise a number of receptacles 32, typically from 1 to 32, which are arranged in a linear fashion with a minimum spacing between adjacent receptacles, typically from 3 mm to 3.5 mm. Typical buffer containers 10 will have a diameter in the range from 11 mm to 12 mm.

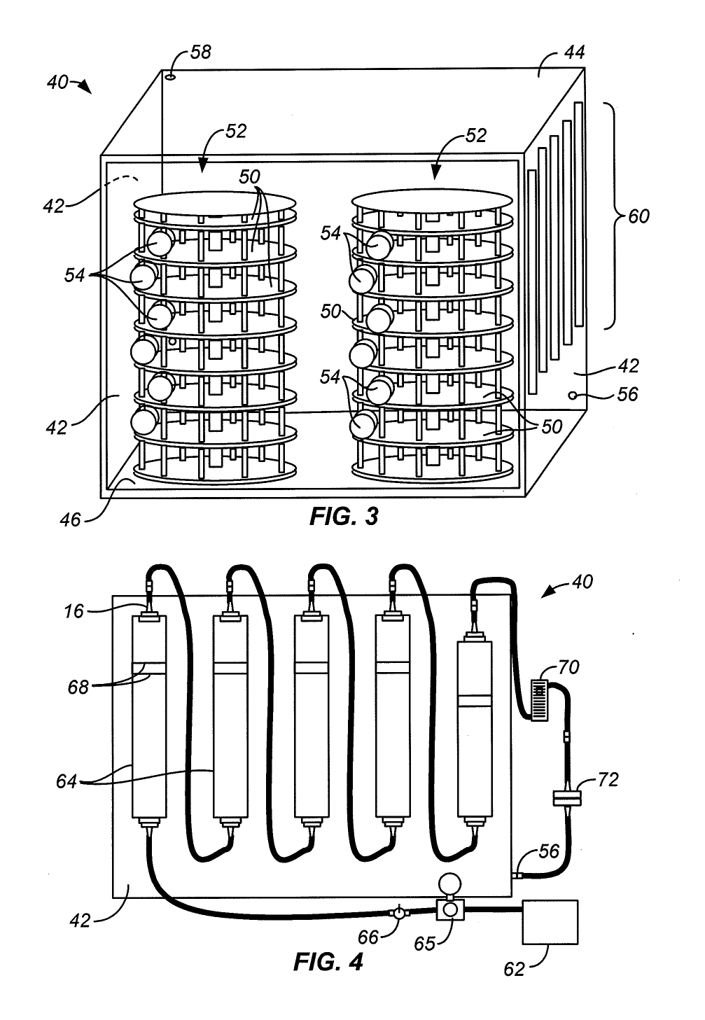

Referring now to FIG. 3, a treatment chamber 40 comprises an enclosure with perimeter walls 42, a top 44, and a bottom 46. The perimeter walls may include one or more large doors (not shown) to permit access to the interior of the chamber. The walls, top, and bottom will provide a contained interior in which the atmosphere can be controlled. The chamber need not be hermetically sealed, and small leakage from the container will be acceptable, provided that the flow rate of gas into the chamber is greater than the amount of leakage. The gas flow which is being introduced (as described below) will continuously replenish the atmosphere and maintain substantially constant conditions within the atmosphere to achieve the desired equilibration of the buffer containers 10, as described below. The exhaust port 58 is sized large enough that gas will escape freely, preventing any buildup of pressure within the chamber.

A plurality of horizontal supports 50 will be provided within the interior of the chamber 40, typically being part of rotatable carousels 52 which will be adapted to rotate at a rate in the range from 2 rpm to 5 rpm. A plurality of pneumostatic ports 54 will be provided in one or more of the perimeter walls 42 to provide access to each of the supports 50 for introducing and removing the buffer containers 10, typically by passing the carriers 30 through the ports. The ports will be designed to minimize the loss of gas from within the chamber during the pass-through process.

The carbon dioxide treatment gas will be introduced through an inlet port 56 near the bottom of the chamber and will be exhausted through an outlet port 58 at or near the top of the chamber. The gas humidifying and supply assembly 60 (FIG. 4) may be provided, typically being mounted on a side of the chamber as shown in FIG. 3. The gas humidifying and supply assembly includes a gas supply 62 which provides a carbon dioxide gas to a series of water columns 64. Typically, the gas will pass through a pressure regulator 65 which maintains sufficient pressure that the gas flows through the columns and the chamber to achieve the flow rate previously described. A valve 66 is provided to allow shut off, and water fill lines 68 on each of the columns 64 to allow filling to the proper level. Optionally, the last column may include a heating element, such as an electric incandescent light bulb, to assure that the gas entering the treatment chamber 40 is slightly above the control temperature for the chamber. By maintaining a slight temperature elevation, typically 1-2° C., the relative humidity of the gas will rise as its temperature lowers to the chamber temperature, thus assuring that the relative humidity remains above the target level. In another configuration, one of the first columns may include a heating element, such as an electric incandescent light bulb, to raise the temperature of this column slightly so that the typically colder gas entering the water column does not reduce the temperature of the other water columns below the temperature of the room. In this manner, the water in the last columns is very close to or equal the temperature of the room, as is the chamber, so that there is little or no change in relative humidity of the gas as it leaves the last water column and enters the chamber. Usually, a flow meter 70 will be provided in the line leading into the treatment chamber 40 and a gas filter 72 will be provided to remove any contaminants and help maintain a clean sterile environment within the chamber.

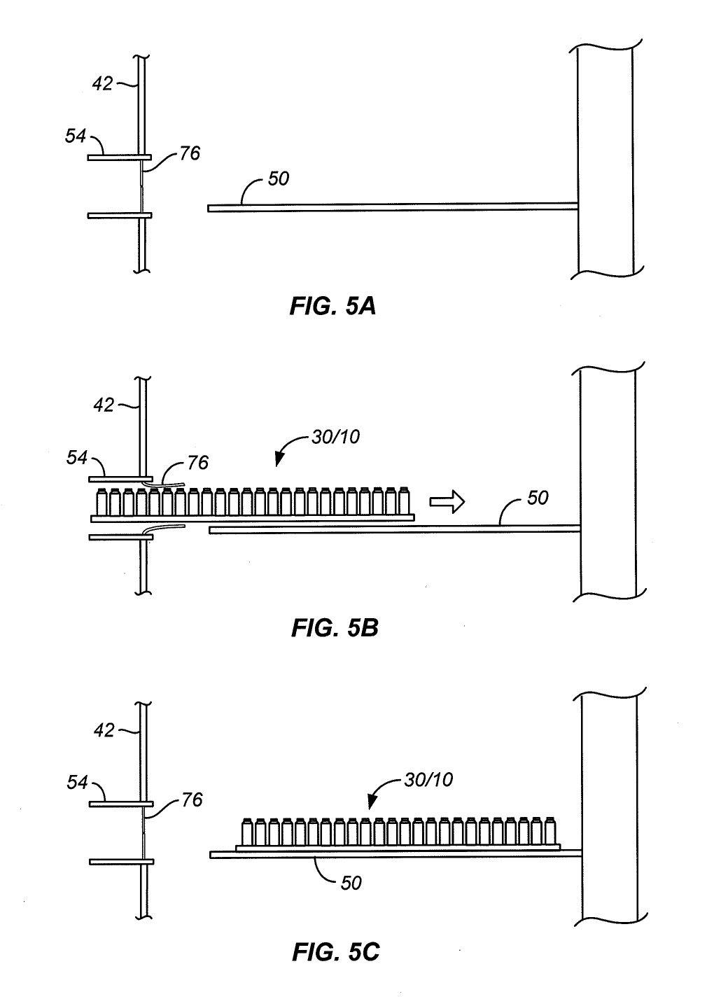

Referring now to FIGS. 5A-5C, passage of the carriers 30 with the containers 10 into the treatment chamber 40 through the hemostatic ports 54 will be described. Each of the hemostatic ports 54 present in the perimeter wall 42 has a gas barrier 76 in the form of a large flap valve, port hole door, curtain or the like. When nothing is passing through the port 54, the gas barrier 76 is closed, as shown in FIG. 5A, to inhibit the loss of gas from the interior of the treatment chamber. The gas barrier 76, however, can be opened by simply passing the carrier 34 therethrough, as shown in FIG. 5B. This allows the carrier to be introduced quickly and placed on the support 50 with only a minimum loss of gas from within the treatment chamber 40. After the carrier 30 is in place on the support 50, as shown in FIG. 5C, the gas barrier 76 will self-close to restore the barrier to gas loss. Even though some gas loss will occur, as the flow of gas is maintained above the volume of losses due to any leakage, the gas will be lost from the interior chamber to the exterior, thus having minimum or no effect on the composition, pressure, and temperature of the gas within the chamber.

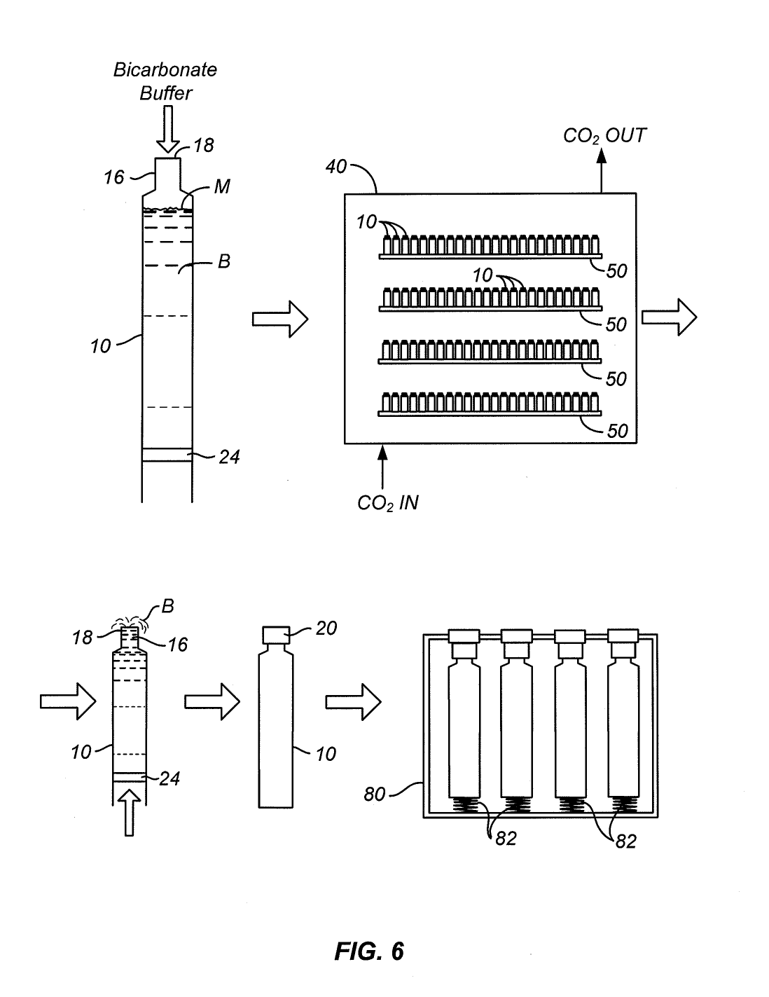

Referring to FIG. 6, the methods for treatment according to the present invention can now be described. Initially, the individual buffer containers 10 are filled with the aqueous bicarbonate buffer B to a point near meniscus M. Usually, the volume of buffer B introduced will be selected so that the upper surface or meniscus M of the buffer lies below the reduced diameter neck 16 so that the meniscus M has a larger surface area than it would have if it were present within the neck. This larger surface area allows more rapid exchange of carbon dioxide gas between the atmosphere in chamber 40 and the buffer in container 10, such that the carbonic acid within the buffer can more rapidly reach equilibrium with the carbon dioxide in the atmosphere within the chamber 40. After filling, the containers 10 are then introduced to the treatment chamber 40, typically after placement on carriers 30 as described with reference to FIGS. 5A-5C above. After the carriers 30 have been loaded onto the supports 50, the containers 10 on the carriers 30 are left to equilibrate with the carbon dioxide environment which is continuously being replenished with the carbon dioxide gas for a number of hours under the conditions described above. After a sufficient time has passed for the buffer within the containers to equilibrate with the carbon dioxide within the treatment chamber 40, the containers are removed and the plungers 24 advanced to raise the level of buffer to the opening 18 in the neck 16. The caps 20 are then placed over the necks 16, leaving little or no head space, and the individual sealed containers 10 then placed in a storage tray 80 where springs 82 can be engaged against the plungers 24 to pressurize the buffers to inhibit the evolution of carbon dioxide gas from the buffer solution. By limiting such evolution, the pH of the buffer will be more stably maintained. The treatment trays 80 are also suitable for autoclaving the containers to assure sterility. The containers may then be combined with an anesthetic or other medical solution in accordance with the methods of the present invention as described below.

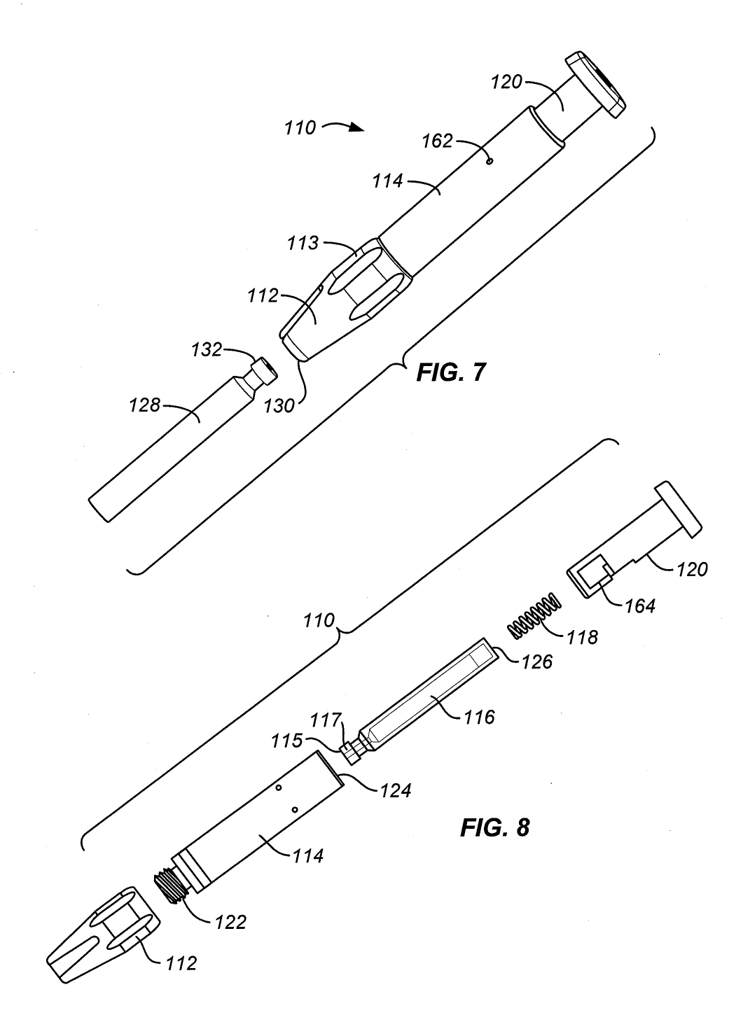

Referring to FIGS. 7 and 8, a buffer transfer device 110 useful for combining precise volumes of buffer with medical solution in a container comprises a knob 112, and housing 114, a buffer cartridge 116, a spring 118 or other compression member, and a pusher 120. The knob 112 is rotatably mounted on threads 122 at the distal end of the housing 114 and the buffer cartridge 116 may be inserted into an open proximal end 124 of the housing. The pusher 120 is introduced through the open end 124 and compresses the spring 118 engaged against a proximal end 126 of the buffer cartridge 116, as will be described in greater detail below. The buffer transfer device 110 detachably receives a conventional anesthetic cartridge 128 within a receptacle 144 (best seen in FIG. 5) at the distal end 130 of the knob 112, which also will be described in greater detail below.

Typically, buffer transfer device 110 will be fully assembled at a central, sterile location and distributed for use. While the temperature and other conditions of distribution can be somewhat controlled, it will be appreciated that a variety of temperatures and other potentially destabilizing conditions might be encountered during distribution and storage prior to use of the device for buffering the anesthetic cartridge. A mechanism for maintaining pressure on the buffer solution within the buffer cartridge 116 will be provided in order to limit the loss of carbon dioxide or other volatile components from bicarbonate or other buffering solutions. The details of the pressurization mechanism are described below.

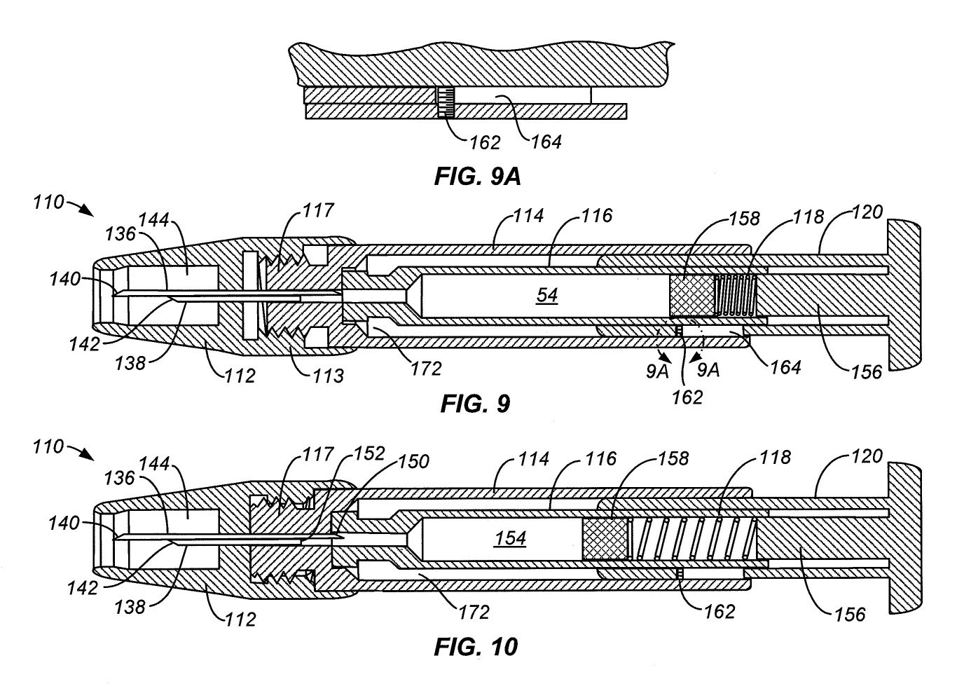

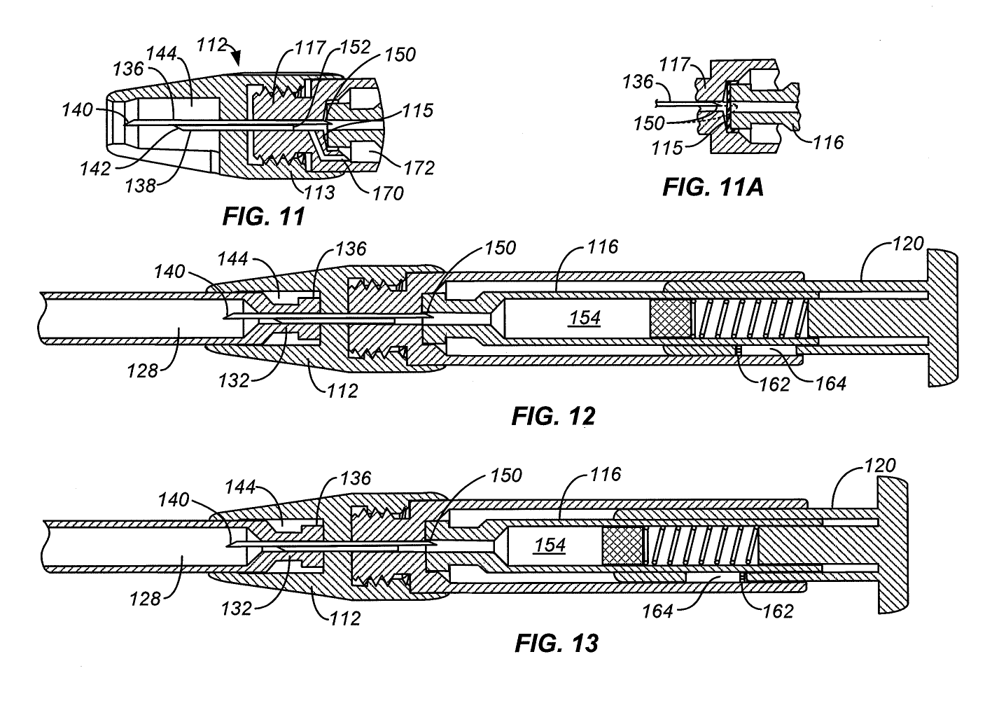

Referring now to FIG. 9, the buffer transfer device 110 in its pre-use or storage configuration is illustrated. The knob 112 includes a transfer needle 136 and an exhaust needle 138, both of which can be more clearly seen in the detailed view of FIG. 11. The transfer and exhaust needles 136 and 138 are illustrated as separate hypotubes or other tubular structures. It will be appreciated, however, they could also be formed as a single, bi-lumen structure, although in all cases, a distal tip 140 of the transfer needle should extend distally beyond a distal tip 142 of the exhaust needle 138. The distal portions of both needles 136 and 138 extend into a receptacle region 144 which receives the septum end 132 of the anesthetic cartridge 128, as will be described in more detail below with respect to FIGS. 11 and 12. By axially spacing apart the distal tips 140 an 142 of the transfer and exhaust needles 136 and 138, mixing between the buffer which is being introduced through the transfer needle and the anesthetic which is being expelled through the exhaust needle will be minimized.

The transfer needle 136 has a proximal end 150 which extends into a threaded region 113 of the knob 112, as best seen in FIG. 11. Proximal end 150 extends sufficiently far so that it will penetrate a septum 115 (best seen in FIG. 11A) formed over the neck 117 of the buffer cartridge 116 when the knob 112 is fully tightened on the threads 117 of the housing 114, as shown in FIG. 10. In contrast, proximal end 152 of the exhaust needle 138 terminates distally of the septum 115 even when the knob is fully tightened.

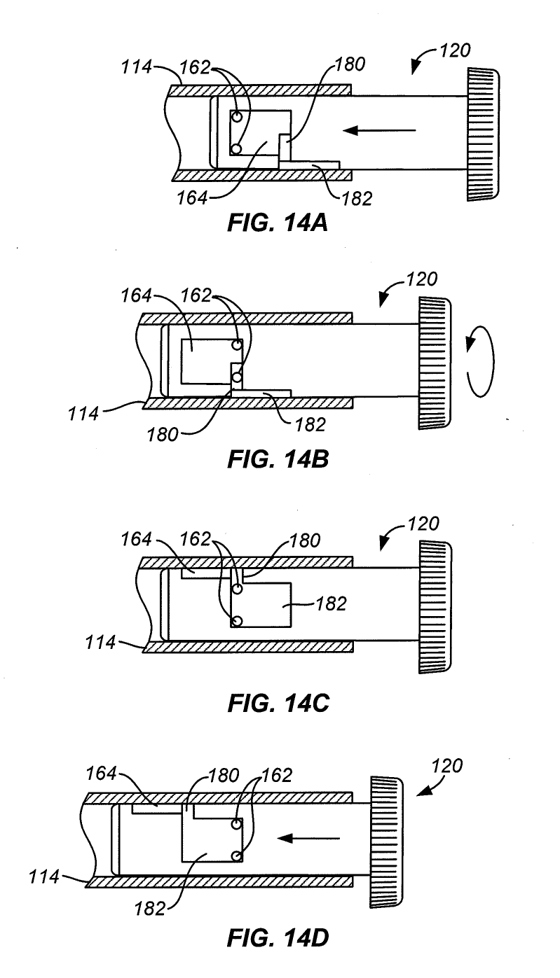

The knob 112 will be tightened over the housing 114 before the anesthetic cartridge 128 is introduced to the receptacle 144. Prior to tightening the knob, the septum 115 remains intact and pressure of buffer within the interior 154 of the cartridge 116 remains above atmospheric as provided by the pressure of spring 118. Spring 118, in turn, remains compressed between extension member 156 of the pusher 120 and a plunger 158 which is slidably received within the open proximal end of the buffer cartridge 116. As soon as the proximal end 150 of transfer needle 136 penetrates the septum 115, as shown in FIG. 10, the pressure on the buffer in interior 154 is released, causing a small flow of buffer through the transfer needle and out through the distal tip 140 in order to prime the transfer needle. The plunger 158 advances under the force of spring 118, and the buffer transfer device 110 is in the condition illustrated in FIG. 10. Note that the proximal movement of the pusher 120 is prevented by a stop member 162 fixed in a wall of the housing 114, as illustrated in FIG. 9A. Stop member 162 engages an edge of window 164 formed in the wall of the pusher 120, as will be described in greater detail below in connection with FIGS. 14A-14D. Preventing the pusher 120 from moving proximally is necessary to maintain the pressure applied by spring 118 on the anesthetic within the interior 154 of the anesthetic cartridge 116.

Referring now to FIG. 12, after the knob 112 has been tightened and the proximal tip 150 of transfer needle 136 has penetrated the septum 115 of buffer cartridge 116, the neck 132 of anesthetic cartridge 128 may be inserted into the receptacle 144 of knob 112, as illustrated in FIG. 12. A first volume of the buffer may then be advanced from the interior 154 of buffer cartridge 116 through transfer needle 136 by distally advancing the pusher 120, as shown in FIG. 13. The length of travel of pusher 120, and thus volume of buffer delivered into the anesthetic cartridge 128, is controlled by travel of the stop member 162 in the window 164. Prior to transferring any buffer, the stop member 162 is positioned at a left hand edge of the window 164, as seen in FIG. 12. The pusher 120 may then be advanced until the stop member 162 engages a right hand edge of the window 164, as shown in FIG. 13.

As the plunger is advanced, transferring buffer through transfer 136 into the anesthetic cartridge 128, an equal volume of anesthetic will flow through the distal end 142 of the exhaust needle 138 and out the proximal end 152 thereof into the neck region 117 of the housing 114. While the exhausted anesthetic is wasted, it is desirable that it be contained within the buffer transfer device to avoid spilling and contamination. To that end, an exhaust passage 170 (FIG. 11) may be formed in the neck 117 to allow the excess anesthetic to flow into a waste receptacle 172 which is formed in the interior of the housing 114 surrounding the exterior of the buffer cartridge 116.

Referring now to FIGS. 14A-14D, advancement of the pusher 120 relative to the housing 114 as controlled by the stop members 162 will be described in more detail. In FIG. 14A, the pusher is shown in the configuration of FIGS. 9, 10, and 12 before the plunger has been advanced or otherwise moved. The stop members 162 (only one of which is visible in FIGS. 9, 10, and 12) are engaged against the left hand wall (as shown in FIGS. 14A-14D) of window 164. When the pusher 120 is advanced to transfer buffer into the anesthetic cartridge, as shown in FIG. 14B, the stop members 162 translate to engage the right hand edge of window 164, stopping advancement of the pusher. If only a single delivery is required, no further structure or manipulations would be needed. However, by providing a second window 82 and the ability to rotate the pusher 120 about its axis, a second delivery volume may be provided. A passage 180 is provided between windows 164 and 162 to allow rotation of the pusher 120 so that the stop members 162 move from window 164 into the second window 182. As the second window 182 is offset to the right relative to the first window 164, further leftward travel out of the pusher is now allowed, until the stop members 162 engage the right hand edge of window 182, as shown in FIG. 14B. A second measured volume of the buffer may be delivered. It will be appreciated that still further window mechanisms could be provided for allowing third, fourth, and perhaps even more volumes of buffer to be delivered from a single buffer transfer device.

It will also be appreciated the transfer device 110 could include mechanisms that allow the user to select the amount of fluid to be transferred in each buffering event. Mechanisms that would allow the replacement of a disposable cartridge 116 with a new disposable cartridge may also be useful, for instance when the first cartridge has been exhausted, Similarly, knob 112 could be disposable, allowing it to be replaced from time to time with a clean sterile knob and tubes. Exhaust tube 138 could deposit exhausted solution into a reservoir, a receptacle, or an absorbent material, which could be replaceable.

While the above is a complete description of the preferred embodiments of the invention, various alternatives, modifications, additions, and substitutions are possible without departing from the scope thereof, which is defined by the claims.

What is claimed is:

1. A method for buffering the pH of a known volume of a medical solution in a container, said method comprising:
providing sodium bicarbonate buffer in a container, wherein the pH of the buffer is accurately known within ±0.2 pH unit; and
combining a selected volume of the buffer from the container with the known volume of the medical solution in the container;
wherein the volume of buffer is selected based on the known volume of the medical solution and on the known pH of the buffer and a target pH of the buffered solution so that the actual pH of the buffered solution is with ±0.2 pH unit of the target.

2. A method as in claim 1, wherein the medical solution comprises an anesthetic solution.

3. A method as in claim 1, wherein the medical solution is in a vial.

4. A method as in claim 1, wherein the medical solution is in a cartridge.

5. A method as in claim 1, wherein the buffer solution is in a vial.

6. A method as in claim 1, wherein the buffer solution is in a cartridge.

7. A method as in claim 1, wherein the combination of the solutions is accomplished by driving solution from the first container into the second container by placing the solution in the first container under a higher pressure than the second container, with a fluid exhaust path from the second container.

8. A method as in claim 2, wherein the anesthetic is selected from the group consisting of lidocaine, articaine, bupivacaine, and mepivicaine.

9. A method as in claim 8, wherein the medical solution further comprises epinephrine.

10. A method as in claim 1, wherein combining comprises penetrating a first end of a transfer needle through a septum in the buffer container and a second end of the transfer needle through a septum in the medical solution container and causing the selected volume of buffer to flow from the buffer container to the medical solution container.

11. A method as in claim 10, wherein combining further comprises penetrating an exhaust needle through the septum in the medical solution container and allowing excess medical solution to bleed from the medical solution container as the buffer enters the medical solution container.

12. A method as in claim 10, wherein the causing the selected volume of buffer to flow comprises advancing a plug in the buffer container to displace the selected volume of buffer from the buffer container.

13. A method as in claim 1, wherein the medical solution comprises lidocaine and wherein sodium bicarbonate buffer with a pH of 7.7±0.3 is combined with the lidocaine at 1 ml buffer per 10 ml lidocaine to achieve a buffered pH of 7.2±0.02.

14. A method as in claim 1, wherein the medical solution comprises lidocaine and wherein sodium bicarbonate buffer with a pH of 7.7±0.15 is combined with the lidocaine at 1 ml buffer per 10 ml lidocaine to achieve a buffered pH of 7.2±0.02.

15. A method as in claim 1, wherein the medical solution comprises lidocaine and wherein sodium bicarbonate buffer with a pH of 7.7±0.10 is combined with the lidocaine at 1 ml buffer per 10 ml lidocaine to achieve a buffered pH of 7.2±0.02.

16. A method as in claim 1, wherein the medical solution comprises local anesthetics other than lidocaine wherein sodium bicarbonate buffer with a pH of 7.7±0.3 is combined with the other local anesthetic at 1 ml buffer per 10 ml local anesthetic to achieve a buffered pH of 7.2±0.2.

17. A method as in claim 1, wherein the medical solution comprises a local anesthetic solution that includes epinephrine.

18. A method as in claim 1, wherein the medical solution comprises a local anesthetic solution that includes hyaluronidase.
